(19) United States
(12) Patent Application Publication
(10) Pub. No.: US 2009/0296691 A1
(43) Pub. Date: Dec. 3, 2009

(54) METHOD FOR MAKING TELEPHONE APPARATUS OPERATIVE WITH MULTIPLE NETWORKS

(75) Inventors: Thomas C. Clifford, Indianapolis, IN (US); Levi Jacob Gamble, Lebanon, IN (US)

Correspondence Address: Thomson Licensing LLC, P.O. Box 5312, Two Independence Way, PRINCETON, NJ, 08543-5312, US

(73) Assignee: Thomson Licensing

(21) Appl. No.: 12/448,579

(22) PCT Filed: Jan. 8, 2007
(86) PCT No.: PCT/US2007/019875

§ 371 Date: Jun. 25, 2009

Related U.S. Application Data
(60) Provisional application No. 60/879,291, filed on Jan. 8, 2007.

(30) Foreign Application Priority Data
Jun. 25, 2007 (US) PCT/US2007/014889

(51) Int. Cl. H04L 12/66

(52) U.S. Cl. 370/352

(57) ABSTRACT

An apparatus having a telephonic communication capability with multiple networks enables users to make telephone calls in a simplified manner. According to an exemplary embodiment, the apparatus includes a memory for storing a first telephone number including an area code, and a processor for receiving a signal to dial the stored first telephone number and for determining whether the first network or the second network is selected. If the first network is selected, the processor causes the stored first telephone number to be dialed. If the second network is selected, the processor enables a user to select between the stored first telephone number and a second telephone number derived from the stored first telephone number by deleting at least the area code. The processor also causes a selected one of the stored first telephone number and the second telephone number to be dialed.

### CROSS REFERENCE TO RELATED APPLICATION

This application claims priority to and all benefits accruing from a PCT application, PCT/US2007/14889, filed Jun. 25, 2007, which claims priority to and all benefits accruing from a provisional application filed in the United States Patent and Trademark Office on Jan. 8, 2007, and there assigned Ser. No. 60/879,291.

### BACKGROUND OF THE INVENTION

1. Field of the Invention

The present invention generally relates to apparatuses having a telephonic communication capability with multiple networks, and more particularly, to a method for enabling users to make telephone calls with such apparatuses in a simplified manner.

2. Background Information

Certain telephone apparatuses may be operative with multiple networks. For example, some telephone apparatuses may be operative with internet-based telephone networks such as the Skype™ network, and also be operative with networks such as a conventional public switched telephone network (PSTN). While the ability to communicate via multiple networks is generally advantageous, it may also create problems given that different networks may use different dialing formats.

For example, certain networks such as a PSTN in the United States typically provide caller identification records using a 10 digit format (e.g., 317-555-1212). Accordingly, with such networks, caller identification records of incoming telephone calls are received and stored in a telephone apparatus in this 10 digit format. When dialing one of these stored telephone numbers, users need to have the option to delete digits from the stored call record, depending on the area of the country they live, and the destination of the telephone number being dialed.

Certain traditional telephone apparatuses may include a “format” key or option which allows users to change a telephone number to a 7, 10 or 11 digit telephone number. Additionally, some telephone apparatuses allow a user to enter local area codes so that the telephone number of an incoming telephone call will be stored as a 7 digit local telephone number, thereby allowing the stored telephone number to be dialed without the user having to format the telephone number. These traditional schemes, however, do not address products that have the ability to dial stored telephone numbers via multiple networks such as internet-based telephone networks (e.g., the Skype™ network), and conventional PSTNs.

Accordingly, there is a need to address the foregoing problem and thereby provide a method that enables users to make telephone calls with telephone apparatuses that are operative with multiple networks in a more simplified manner. The present invention addresses these and/or other issues.

### SUMMARY OF THE INVENTION

In accordance with an aspect of the present invention, a method for making a call via an apparatus operative with first and second networks is disclosed. According to an exemplary embodiment, the method comprises steps of: storing a first number; receiving a signal to make a call with the stored first number; determining whether the first network or the second network is selected; if the first network is selected, transmitting the stored first number; if the second network is selected, enabling a user to select between the stored first number and a second number derived from the stored first number; and transmitting a selected one of the stored first number and the second number.

In accordance with another aspect of the present invention, an apparatus having a communication capability with first and second networks is disclosed. According to an exemplary embodiment, the apparatus comprises data storage means such as a memory for storing a first number, and processing means such as a microprocessor for receiving a signal to make a call with the stored first number and for determining whether the first network or the second network is selected. If the first network is selected, the processing means causes the stored first number to be transmitted. If the second network is selected, the processing means enables a user to select between the stored first number and a second number derived from the stored first number. The processing means causes a selected one of the stored first number and the second number to be transmitted.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram of a relevant portion of a telephone apparatus according to an exemplary embodiment of the present invention;

FIG. 2 is a flowchart illustrating steps for making a telephone call according to an exemplary embodiment of the present invention; and

FIGS. 3 to 5 are user interfaces for enabling users to make telephone calls according to exemplary embodiments of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

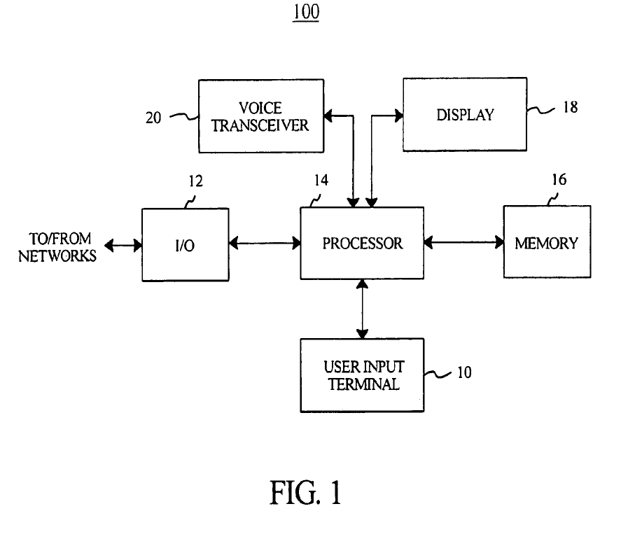

Referring now to the drawings, and more particularly to FIG. 1, a block diagram of a relevant portion of a telephone apparatus 100 according to an exemplary embodiment of the present invention is shown. As indicated in FIG. 1, telephone apparatus 100 comprises user input means such as user input terminal 10, input/output (I/O) means such as I/O block 12, processing means such as processor 14, data storage means such as memory 16, visual I/O means such as display 18, and aural I/O means such as voice transceiver 20. Some of the foregoing elements of telephone apparatus 100 may be implemented using one or more integrated circuits (ICs). For clarity of description, certain conventional elements associated with telephone apparatus 100 such as certain control signals, power signals and/or other elements may not be shown in FIG. 1. According to an exemplary embodiment, telephone apparatus 100 of FIG. 1 may be implemented as any type of device, system and/or apparatus having a telephonic communication capability, and may for example be integrated into devices, systems and/or apparatuses having other capabilities such as audio and/or video processing capabilities.

User input terminal 10 is operative to receive inputs from users, and to output signals corresponding to the user inputs to processor 14. According to an exemplary embodiment, user input terminal 10 may be implemented as a keypad having a plurality of keys that enable numeric and alphabetic input capabilities. User input terminal 10 may also include voice input capabilities. User input terminal 10 may for example be illuminated when in use (e.g., via light emitting diodes (LEDs) and/or other illumination means).

I/O block 12 is operative to perform I/O functions of telephone apparatus 100. According to an exemplary embodiment, I/O block 12 is operative to transmit signals to and receive signals from other devices, systems and/or apparatuses in various different networks, including an internet-based telephone network such as the Skype™ or other network, and a PSTN. I/O block 12 may include one or more antenna elements, plugs, and/or other types of I/O elements.

Processor 14 is operative to perform various signal processing and control functions of telephone apparatus 100. According to an exemplary embodiment, processor 14 is operative to execute software code that enables users to make outgoing telephone calls in a simplified manner according to principles of the present invention. According to this exemplary embodiment, processor 14 is operative to perform and/or enable functions of telephone apparatus 100 including detecting and processing user inputs made via user input terminal 10, reading and writing data from and to memory 16, performing call processing functions including dialing out and call receiving functions, enabling display of user interfaces via display 18, and/or other functions.

As used herein, the term “dialing” means transmitting a signal representing a telephone number to a server in the network, so that the server can connect a telephone identified by the transmitted telephone number to the telephone apparatus 100 via the network.

Memory 16 is operative to perform data storage functions of telephone apparatus 100. According to an exemplary embodiment, memory 16 stores data including executable software code, on-screen display data, telephone numbers of previously dialed calls and incoming calls, user setup data, and/or other data.

Display 18 is operative to provide visual displays under the control of processor 14. According to an exemplary embodiment, display 18 provides visual displays of user interfaces that enable users to make outgoing telephone calls in a simplified manner according to principles of the present invention. Display 18 may also be implemented as a touch-screen. In such a case, display 18 may include touch icons that correspond to one or more keys of user input terminal 10. Voice transceiver 20 is operative to transmit and receive voice data to and from processor 14 during telephone calls.

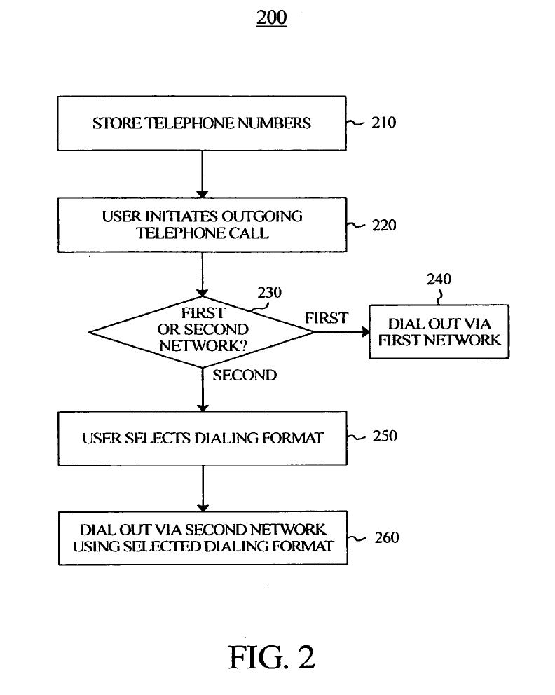

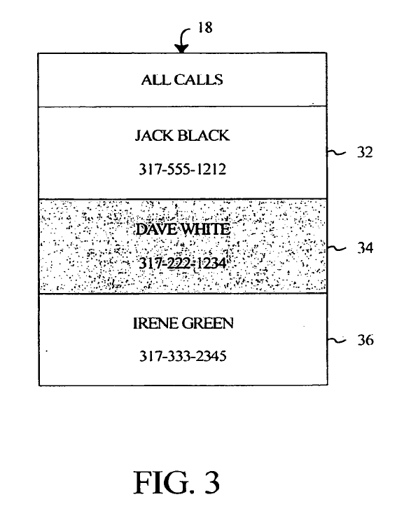

Referring now to FIG. 2, a flowchart 200 illustrating steps for making a telephone call according to an exemplary embodiment of the present invention is shown. For purposes of example and explanation, the steps of FIG. 2 will be described with reference to telephone apparatus 100 of FIG. 1 and the exemplary user interfaces shown in FIGS. 3 to 5. The steps of FIG. 2 are exemplary only, and are not intended to limit the present invention in any manner.

At step 210, telephone apparatus 100 stores a plurality of telephone numbers. A telephone number includes first and second portions. The first portion must be used regardless of which of the first and second networks is selected, whereas the second portion is not always used in a call. If the first network, such as the Internet-based telephone network, is selected, all of the second portion must be used in a call. If the second network, such as a PSTN, is selected, some or all of the second portion may not be needed.

The first portion may be under different names in different countries. For example, it may be called a subscriber code or local code in many countries. The number of digits in the first portion may be different from country to country. For example, in the US, the first portion has seven digits. In some countries, the number of digits of the first portion may not be fixed. For example, it may vary from five digits to eight digits.

The second portion normally is prepended to the first portion to form a stored telephone number. The second portion may include an area code, a country code, and an access code, such as carrier and switch selection codes. Normally, the area code is prepended first followed by the country code and the access code. In the past, an area code was normally assigned to a geographical area. It is no longer the case. For example, some area codes may be allocated for cell phone use and other special purposes such as toll free calls. As such, as used herein, an area code may be geographic or non-geographic, and may be called under a different name. A country code is used to identify a country. An access code can be added to a number with an area code and the first portion or with a country code, an area code, and the first portion. An access code may be used to identify the type of a call. For example, dialing one first in the US may indicate that the call is a long distance call and dialing 011 may indicate that the call is an international call. Access codes can be used to select different carriers in some countries as well. In this example, a stored telephone number includes only the first portion and an area code, but this is only exemplary. A stored number may also include a country code and/or an access code as defined above.

According to an exemplary embodiment, memory 16 stores telephone numbers of all outgoing and incoming telephone calls of telephone apparatus 100, including the area codes associated with such telephone numbers, at step 210. Memory 16 may also store telephone numbers including associated area codes at step 210 that are downloaded to telephone apparatus 100 from other devices, systems and/or apparatuses via I/O block 12. According to an exemplary embodiment, telephone numbers of outgoing and incoming telephone calls of telephone apparatus 100 may also be stored on a server (not shown in FIGS.) associated with one or more of the networks in which telephone apparatus 100 is operative. For example, telephone numbers of outgoing and incoming telephone calls may be stored on a server associated with an internet-based telephone network, such as a server associated with the Skype™ and/or other network.

At step 220, a user initiates an outgoing telephone call via telephone apparatus 100. According to an exemplary embodiment, the user may initiate the outgoing telephone call at step 220 by scrolling through a displayed list of the telephone numbers stored at step 210, and selecting a desired one of the telephone numbers. FIG. 3 shows an exemplary list of such telephone numbers, including the parties' names, which are represented by reference numbers 32, 34 and 36. The number of individual telephone numbers that are displayed at one time on display 18 may be set as a matter of design choice. For purposes of example and explanation, the exemplary list of FIG. 3 displays three individual telephone numbers at one time.

The user may scroll through the list of stored telephone numbers by pressing predetermined keys (e.g., up/down keys, etc.) on user input terminal 10 (or on display 18 if it is implemented as a touch-screen). Once a desired telephone number is highlighted through the scrolling process, the user may press one or more predetermined keys (e.g., select, dial, etc.) on user input terminal 10 (or on display 18 if it is implemented as a touch-screen) to thereby select and initiate dialing of the highlighted telephone number. In FIG. 3, for example, it is assumed that the user has highlighted and selected the telephone number “317-222-1234” for dialing at step 220. Once a desired telephone number is selected, a signal is sent from user input terminal 10 (or display 18 if it is implemented as a touch-screen) to processor 14 to initiate dialing of the selected telephone number. It is noted that the user could also initiate the outgoing telephone call at step 220 through other means, such as by providing a voice command via user input terminal 10.

At step 230, a determination is made as to whether the outgoing telephone call is to be made via a first network or a second network. According to an exemplary embodiment, the first network is an internet-based telephone network such as the Skype™ or other network, and the second network is a PSTN. In practice, however, other networks may represent the first and second networks. Processor 14 makes the determination at step 230 based on a user selection of either the first network or the second network. This selection may occur before or after the user initiates the outgoing telephone call at step 220.

According to one exemplary embodiment, the user makes the selection before initiating the outgoing telephone call at step 220 by selecting either the first network or the second network during a user setup process for telephone apparatus 100. With this exemplary embodiment, the user selects either the first network or the second network to handle all outgoing telephone calls made via telephone apparatus 100, and data corresponding to this user setup selection is stored in memory 16. According to another exemplary embodiment, the user makes the selection immediately after initiating the outgoing telephone call at step 220, and thereby selects between the first network and the second network on a call-by-call basis.

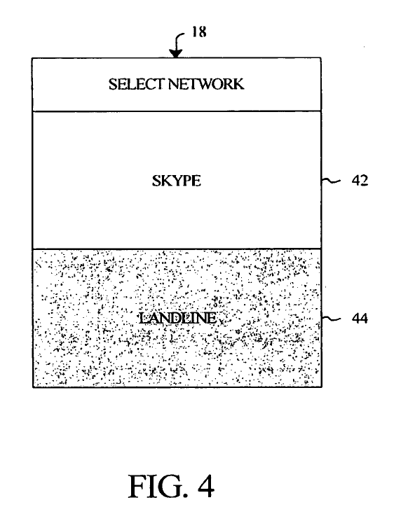

Regardless of whether the selection occurs before or after the user initiates the outgoing telephone call at step 220, the selection itself may be facilitated by a user interface, such as the one shown in FIG. 4. As indicated in FIG. 4, the user may highlight and select either the first network (i.e., the Skype™ network) represented by reference number 42 or the second network (i.e., a landline or PSTN network) represented by reference number 44 using one or more predetermined keys (e.g., up, down, select, etc.) on user input terminal 10 (or on display 18 if it is implemented as a touch-screen). As indicated above, processor 14 makes the determination at step 230 based on this user selection.

If the determination at step 230 indicates that the first network is to be used for the outgoing telephone call, process flow advances to step 240 where the outgoing telephone call is made under the control of processor 14 by dialing out via the first network (e.g., the Skype™ network or other internet-based network). It is noted that if the first network is used for the outgoing telephone call, then the telephone number may be dialed as stored on a server (not shown in FIGS.) for the first network.

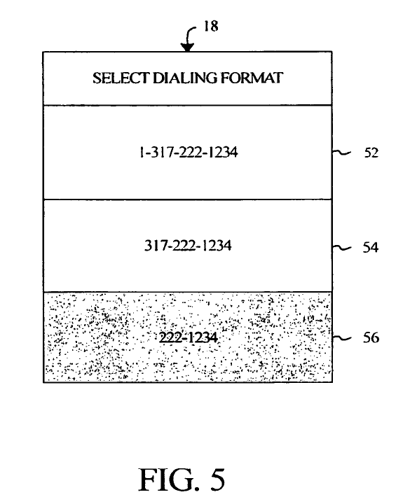

Alternatively, if the determination at step 230 indicates that the second network is to be used for the outgoing telephone call, process flow advances to step 250 where the user selects a dialing format for the telephone number selected at step 220 under the control of processor 14. According to an exemplary embodiment, the user selects from among at least three different dialing formats at step 250. These three different dialing formats include the 11, 10 and 7 digit versions of the selected telephone number, as represented in FIG. 5 by reference numbers 52, 54 and 56, respectively. As indicated in FIG. 5, the 11 digit version of the selected telephone number represented by reference number 52 includes the digit “1” as well as the area code “317”. The 10 digit version of the selected telephone number represented by reference number 54 includes the area code “317” but excludes the digit “1”. The 7 digit version of the selected telephone number represented by reference number 56 excludes both the digit “1” and the area code “317”. Other numbers can be derived from the selected stored number and added to the list of choices as well. For example, a country code and/or an access code can be added to form more numbers for user selection.

From the user interface of FIG. 5, the user may simply highlight a desired one of the three different versions of the selected telephone number, and then press one or more predetermined keys (e.g., select, dial, etc.) on user input terminal 10 (or on display 18 if it is implemented as a touch-screen) to thereby select the desired dialing format at step 250 and cause it to be dialed. According to an exemplary embodiment, if the user has previously entered an area code when dialing a selected telephone number, then the 7 digit version of the selected telephone number may be highlighted as a default, but the user can still select the 10 or 11 digit versions, if desired.

After the user selects a dialing format at step 250, process flow advances to step 260 where telephone apparatus 100 dials out the selected telephone number via the second network (e.g., a landline or PSTN network) under the control of processor 14 using the dialing format selected at step 250.

Although the stored numbers are described as telephone numbers, they are only exemplary. They can be numbers in any addressing scheme, which identify network terminals, such as phones and personal computers. For example, the numbers may represent network addresses and the network terminals are personal computers addressed by those respective network addresses.

As described herein, the present invention provides a method for enabling users to make telephone calls with telephone apparatuses that are operative with multiple networks in a simplified manner. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method (200) for making a call via an apparatus operative with first and second networks, the method comprising steps of:
storing a first number;
receiving a signal to make a call with the stored first number;
determining whether the first network or the second network is selected;
if the first network is selected, transmitting the stored first number;
if the second network is selected, enabling a user to select between the stored first number and a second number derived from the stored first number; and
transmitting a selected one of the stored first number and the second number.

2. The method claim 1, wherein the first network is an internet-based telephone network.

3. The method of claim 1, wherein the second network is a public switched telephone network.

4. The method of claim 1, wherein the selection of the first network or the second network occurs before the receiving step.

5. The method of claim 4, wherein the selection of the first network or the second network occurs during a setup process for the apparatus in which the user selects one of the first and second networks to handle all outgoing calls made via the apparatus.

6. The method of claim 1, wherein the selection of the first network or the second network occurs after the receiving step.

7. The method of claim 6, wherein the selection of the first network or the second network is made by the user on a call-by-call basis.

8. The method of claim 1, wherein the first number includes a first portion that must be included in a call and a second portion including at least one code and the second number is derived from the first number by deleting one of the at least one code of the second portion.

9. The method of claim 1, wherein the second number is derived from the first number by adding at least one digit to the first number.

10. (canceled)

11. (canceled)

12. (canceled)

13. (canceled)

14. (canceled)

15. (canceled)

16. (canceled)

17. (canceled)

18. (canceled)

19. An apparatus having a communication capability with first and second networks, the apparatus comprising:
a memory operative to store a first number;
a processor operative to receive a signal to make a call with the stored first number and to determine whether the first network or the second network is selected, wherein:
if the first network is selected, the processor causes the stored first number to be transmitted;
if the second network is selected, the processor enables a user to select between the stored first number and a second number derived from the stored first number; and
the processor causes a selected one of the stored first number and the second number to be transmitted.

20. The apparatus of claim 19, wherein the first network is an internet-based telephone network.

21. The apparatus of claim 19, wherein the second network is a public switched telephone network.

22. The apparatus of claim 19, wherein the selection of the first network or the second network occurs before the processor receives the signal to dial the stored first number.

23. The apparatus of claim 22, wherein the selection of the first network or the second network occurs during a setup process for the apparatus in which the user selects one of the first and second networks to handle all outgoing calls made via the apparatus.

24. The apparatus of claim 19, wherein the selection of the first network or the second network occurs after the processor receives the signal to dial the stored first number.

25. The apparatus of claim 24, wherein the selection of the first network or the second network is made by the user on a call-by-call basis.

26. The apparatus of claim 19, wherein the first number includes a first portion that must be included in a call and a second portion including at least one code and the second number is derived from the first number by deleting one of the at least one code of the second portion.

27. The apparatus of claim 19, wherein the second number is derived from the first number by adding at least one digit to the first number.
